(19) United States
(12) Patent Application Publication
(10) Pub. No.: US 2014/0095116 A1
(43) Pub. Date: Apr. 3, 2014

(54) MEASURING DEVICE AND A MEASURING METHOD WITH COUPLED DISPLAY

(71) Applicant: Rohde & Schwarz GmbH & Co. KG, Munich (DE)

(72) Inventor: Matthias Keller, Kirchheim (DE)

(21) Appl. No.: 14/039,694

(22) Filed: Sep. 27, 2013

(30) Foreign Application Priority Data
Sep. 28, 2012 (DE) 10 2012 217 726.4

(51) Int. Cl. G01D 7/00

(52) U.S. Cl. CPC G01D 7/00
USPC 702/189

(57) ABSTRACT

A measuring device according to the invention comprises at least a first detector and a second detector for detecting a signal. It further comprises a control device and a display device. In this context, the control device is set up to cause the first detector and/or the second detector to be supplied with the first signal. The control device is further set up to selectively display the signal detected by the first detector by means of the display device in a first display region and in a second display region when a user entry determines a display in one of the display regions, and/or to display the signal detected by the second detector by means of the display device in the first display region and in the second display region when a user entry determines a display in one of the display regions.

### TECHNICAL FIELD

The invention relates to a measuring device, preferably a measuring receiver, for example, for measuring electromagnetic compatibility EMC, and a corresponding method for operating the measuring device.

### BACKGROUND OF THE INVENTION

Conventional measuring receivers optionally provide several detectors. These detectors can be supplied either in an alternating manner or in parallel with the preprocessed measurement signal to be detected. The results of the detection from the individual detectors are displayed by conventional measuring receivers on a display device. In this context, different display modes, for example, a bar-graph display or a spectral display can be displayed in different regions of the display device. In order to switch between the individual display modes of the individual detectors, it is conventionally necessary to select the detector and the display mode separately for each display region.

Accordingly, for example, the German patent application DE 103 37 913 A1 discloses a measuring device with several such detectors.

The disadvantage here is that, particularly when displaying the measurement result of a detector in different display modes in different display regions, high operating efforts are incurred in order to make a change in the signal displayed, for example, a change of detector or of the display mode of the signal, in all of the display regions.

The invention is based upon the object of providing a measuring device and a measuring method which allow a clearly arranged display of the measurement results with low operating efforts.

### SUMMARY OF THE INVENTION

A measuring device according to the invention comprises at least a first detector and a second detector for detecting a signal. It further comprises a control device and a display device. In this context, the control device is set up to cause the first detector and/or the second detector to be supplied with the first signal. The control device is further set up to selectively display the signal detected by the first detector by means of the display device in a first display region and in a second display region when a user entry determines a display in one of the display regions, and/or to display the signal detected by the second detector by means of the display device in the first display region and in the second display region when a user entry determines a display in one of the display regions. This means that the user only needs to make changes in the displayed detector type in a first display region in order to achieve the display of the signals of the currently selected detectors in all of the display regions.

By preference, this procedure is adopted with different display modes in the different display regions. Accordingly, an appropriate display mode is automatically selected for the different display regions. This additionally facilitates operation by the user.

In the case of a user entry which determines a change in a display mode of the display of the signal detected by a detector, the control device is preferably set up to control the display device in such a manner that the change in the display mode is made in all of the display regions in which the signal detected by the detector is displayed. This also includes, for example, a matching of a frequency range or a change in the length of a time window or a matching of the trace time. Accordingly, the user can recognise a current measurement result directly after a change to a display region without manually matching the settings of all the display regions.

The measuring device preferably comprises from one to eight detectors. By preference, these are each of different types.

Accordingly, the detectors preferably comprise a maximum-level detector and/or a maximum-trace detector and/or an average-level detector and/or a minimum-level detector and/or a mean power detector and/or a weighted level detector and/or a time-constant level detector and/or a mean power time-constant detector. In this manner, the measured results can be conditioned in the most diverse manner possible without unnecessary hardware costs.

A measurement method according to the invention can be used for the measurement and display of a signal. The signal is detected by means of at least a first detector and a second detector. The signal detected by the first detector is displayed selectively by means of a display device in a first display region and in a second display region when a user entry determines a display in one of the display regions. The signal detected by the second detector is displayed by means of the display device in a first display region and in a second display region when a user entry determines a display in one of the display regions. This means that the user only needs to implement changes in the displayed detector type in a first display region in order to achieve the display of the signals of the currently selected detectors in all of the display regions.

### BRIEF DESCRIPTION OF THE DRAWINGS

In the next section, the invention is described by way of example with reference to the drawings in which advantageous exemplary embodiments of the invention are presented. The drawings show:

FIG. 1 an exemplary embodiment of a block-circuit diagram of the measuring device according to the invention;

FIG. 2 an exemplary display on a display device of the exemplary embodiment of the measuring device according to the invention; and

FIG. 3 an exemplary embodiment of the measuring method according to the invention.

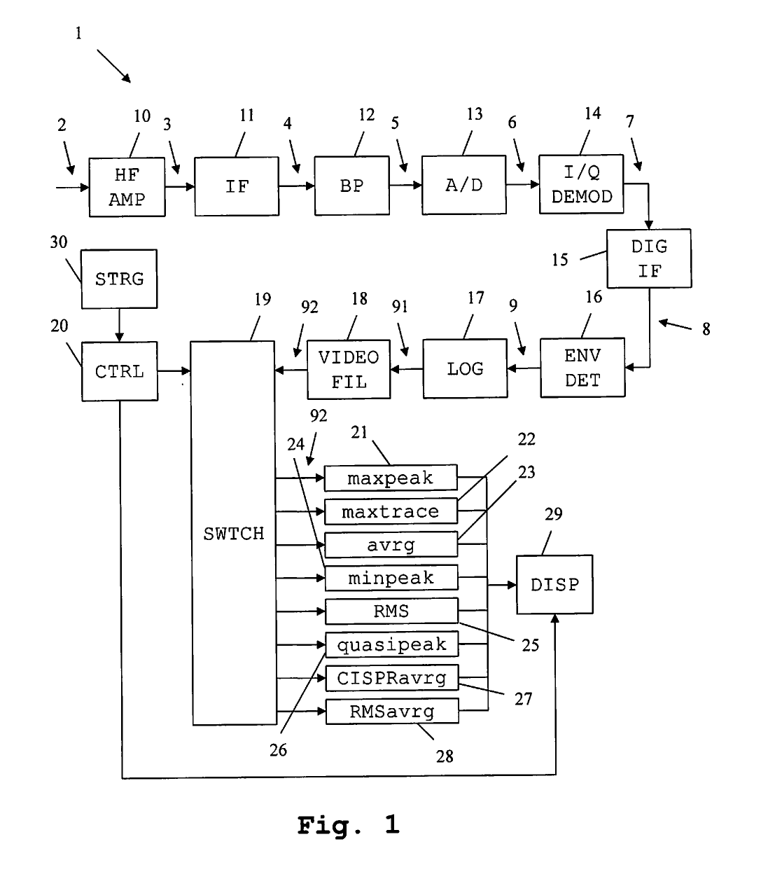

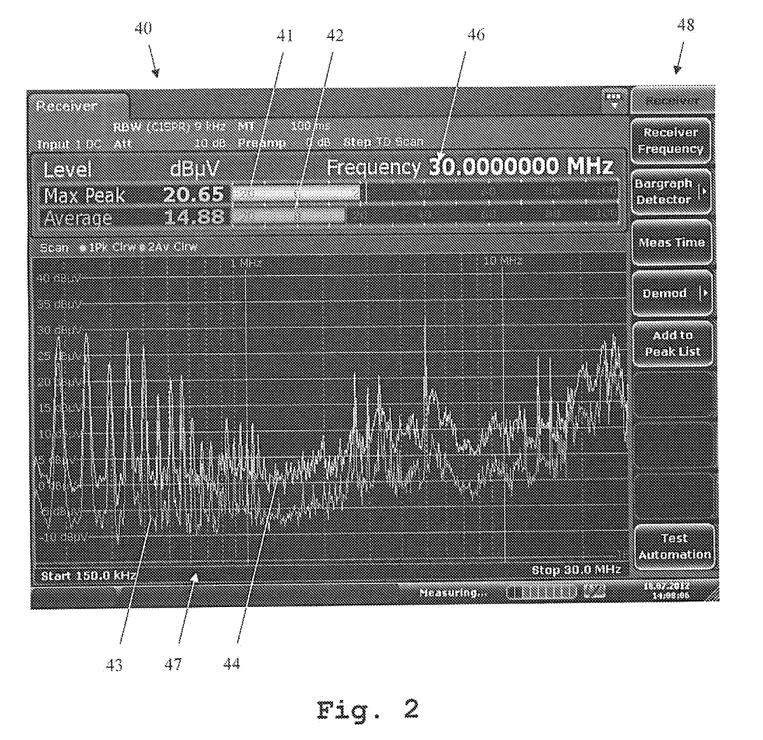

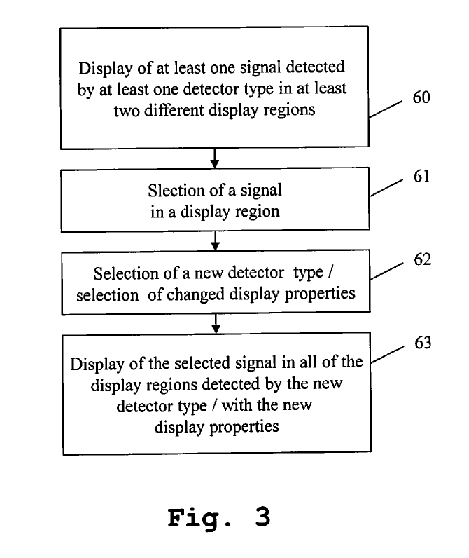

Initially, the structure and the general method of functioning of an exemplary embodiment of the measuring device according to the invention will be presented with reference to FIG. 1. Following this, the clear visual arrangement of the resulting display on the display device is explained with reference to FIG. 2. Finally, the functioning of an exemplary embodiment of the measuring method according to the invention is explained with reference to FIG. 3. The presentation and description of identical elements in similar drawings has not been repeated in some cases.

### DETAILED DESCRIPTION OF THE PREFERRED EMBODIMENTS

### First Embodiment

FIG. 1 shows an exemplary embodiment of the measuring device 1 according to the invention. A high-frequency amplifier 10 is connected to an intermediate-frequency mixer 11. The intermediate-frequency mixer 11 is connected to a band-pass filter 12, which is connected in turn to an analog/digital converter 13. This is connected to an I/Q demodulator 14. The I/Q demodulator 14 is connected to a digital intermediate-frequency filter 15. This is connected in turn to an envelope-detector 16. The envelope detector 16 is connected to a logarithmic amplifier 17, which, for its part, is connected to a video filter 18. The video filter 18 is connected to a switching device 19, which is connected to a plurality of detectors 21-28. The detectors 21-28 are, in turn, connected to a display device 29.

Moreover, the measuring device 1 comprises an entry device 30 which is connected to a control device 20. The control device 20 is additionally connected to the switching device 19 and to the display device 29.

A high-frequency signal 2 is supplied to the high-frequency amplifier 10 and amplified by it. The resulting, amplified high-frequency signal 3 is supplied to the intermediate-frequency mixer 11. The latter mixes it with a local oscillator signal and accordingly generates an intermediate-frequency signal 4. This is supplied to the band-pass filter 12 and filtered by the latter to form a filtered intermediate-frequency signal 5. The filtered intermediate-frequency signal 5 is supplied to the analog-digital converter 13 and converted by the latter into a digitised intermediate-frequency signal 6. This is supplied to the I/Q demodulator 14, which implements an I/Q demodulation to form a digital, demodulated signal 7. The latter is supplied to the digital intermediate-frequency filter 15 and filtered by the latter to form a filtered, digital intermediate-frequency signal 8. This is supplied to the envelope detector 16, which converts it into a signal 9. This signal 9 is supplied to the logarithmic amplifier 17, which generates from it a log signal 91. This signal 91 is supplied to the video filter 18 which filters it again and accordingly generates a signal 92. The resulting signal 92 is supplied by the switching device 19 optionally to one or more of the detectors 21-28. Each detector 21-28 to which the signal 92 is supplied implements a detection and transmits its output signal to the display device 29.

In this context, the switching device 19 is controlled by the control device 20. The display device 29 is also controlled by the control device 20. By means of a user entry through the entry device 30, the control device 20 is instructed regarding which detectors are to be used and how the signals should be displayed on the display device 29.

As an alternative, it is also always possible to supply all of the detectors 21-28 with a signal 92 but only to read out one or more output signals in a targeted manner from one or more of the detectors 21-28. Accordingly, the switching device 19 can be arranged at the output of the detectors 21-28, and the signal 92 is supplied in parallel to all of the detectors 21-28.

The detector 21 thus detects a maximum level within a defined time window (maximum-level detector, maxpeak). Detector 22 detects a maximum level from a plurality of signal traces (maximum trace detector, maxtrace). Detector 23 detects an average level in a defined time window (average level detector, average). Detector 24 detects a minimum level within a defined time window (minimum level detector, minpeak). Detector 25 detects a mean power within a defined time window (mean power detector, RMS). Detector 26 weights the measured values with a predefined weighting function (weighted level detector, quasipeak). Detector 27 simulates the time constant of an analog measuring device. That is to say, the rise of the measured value and the scan of the measured value are delayed (time-constant level detector, CISPR average). Detector 28 combines the power measurement with a simulation of the analog measuring instrument (power time-constant level detector, RMS average).

FIG. 2 shows an exemplary view of a display device 40 which corresponds to the display device 29 from FIG. 1. The display device 40 provides a first display region 46 and a second display region 47. In the first display region 46, the signals 41, 42 from two different detectors are displayed in a bar display. The signal 41 here corresponds to the maximum level in a time window of 100 ms at a frequency of 30 MHz. Signal 42 corresponds to an average level in a time window of 100 ms at a frequency of 30 MHz. The measurement results from the two detectors upon which the signals 41 and 42 are based are also displayed in the second display region 47. Accordingly, a signal 43 shows the average level within the time window of 100 ms as a spectral display from 150 kHz to 30 MHz. A signal 44 therefore shows the maximum level within the time window of 100 ms as a spectral display from 150 kHz to 30 MHz. Operating elements by means of which the displayed signals can be adjusted are presented in a third display region 48.

If the detector used for the first signal 41 is now changed by means of a user entry to a mean power detector (RMS), the switching device 19 from FIG. 1 switches from detector 21 to detector 25 under the control of the control device 20. At the same time, the display device is changed in such a manner that the measured result of the mean power detector is now displayed in the first display region 46. However, at the same time, the display of the signal 44 in the second display region 47 is also automatically changed, so that the measurement result of the mean power detector is displayed here also. Accordingly, changes of the detector or of the signal or the signal properties in one display region also always take effect in all of the other display regions in which the corresponding signals are displayed.

### Second Embodiment

FIG. 3 shows an exemplary embodiment of the method according to the invention as a flow chart. In a first step 60, at least one signal which has been detected by at least one detector type is displayed in two different display regions of the display device. In a second step 61, a signal is selected in one of the display regions by means of a user entry. In a third step 62, a new detector type or a changed display property is selected for the previously selected signal. In a fourth step 63, the selected signal is displayed both in the selected display region and also in all other display regions in which it is displayed with the changed display properties or the changed detector type.

The invention is not restricted to the exemplary embodiment presented. As already mentioned, an extremely diverse range of detectors or measuring devices can be used. All of the features described above or shown in the drawings can be advantageously combined with one another as required within the framework of the invention.

Although the present invention and its advantages have been described in detail, it should be understood that the various changes, substitutions and alterations can be made herein without departing from the spirit and scope of the invention as defined by the appended claims.

What we claim:

1. A measuring device, comprising:
at least a first detector and a second detector for detecting a signal;
a control device; and
a display device,
wherein the control device is set up to cause at least one of the first detector and the second detector to be supplied with a first signal or to read out a signal from at least one of the first detector and the second detector in a targeted manner, and
wherein the control device is set up to display the signal detected by at least one of the first detector and the second detector via the display device in a first display region and in a second display region when a user entry determines a display of the signal detected by at least one of the first detector and the second detector in one of the display regions.

2. The measuring device according to claim 1, wherein the control device is set up to display the signal detected by at least one of the first detector and the second detector via the display device in the first display region in a first display mode and in the second display region in a second display mode when a user entry determines a display of the signal detected by at least one of the first detector and the second detector in one of the display regions.

3. The measuring device according to claim 1, wherein the control device is set up to control the display device in a case of a user entry which determines a change of a display mode of the display of the signal detected by a detector in a display region in such a manner that the change of the display mode is implemented in all of the display regions in which the signal detected by the detector is displayed.

4. The measuring device according to claim 1, wherein the signal detected by the detectors is derived from a measurement signal.

5. The measuring device according to claim 1, further comprising a switching device, which is set up to supply the signal selectively to the detectors,
wherein the control device is set up to control the switching device.

6. The measuring device according to claim 1, further comprising an operating device, which is set up to process the user entry,
wherein the control device is set up to control the operating device and to receive the user entry from it.

7. The measuring device according to claim 1, further comprising at least one of a third detector, a fourth detector, a fifth detector, a sixth detector, a seventh detector, and an eighth detector,
wherein the control device is set up to display the signal detected by one or more of the detectors via the display device selectively in a first display region and in a second display region when a user entry determines a display in one of the display regions.

8. The measuring device according to claim 1, wherein the detectors comprise at least one of a maximum-level detector, a maximum trace detector, an average level detector, a minimum level detector, a mean power detector, a weighted level detector, a time-constant level detector, and a mean-power time-constant detector.

9. The measuring device according to claim 1, wherein all of the detectors are of different detector types.

10. A measuring method for measuring and displaying a signal, comprising:
detecting a signal by at least one of a first detector and a second detector; and
displaying the signal detected by at least one of the first detector and the second detector, in a selective manner, via a display device in a first display region and in a second display region when a user entry determines a display of the signal detected by at least one of the first detector and the second detector in one of the display regions.
